(19) United States
(12) Patent Application Publication
(10) Pub. No.: US 2013/0011216 A1
(43) Pub. Date: Jan. 10, 2013

(54) Drive Formation for a Rotary Drive

(75) Inventor: Uwe Frank, Pfedelbach-Windischenbach (DE)

(73) Assignee: WÜRTH INTERNATIONAL AG, Chur (CH)

(21) Appl. No.: 13/634,595

(22) PCT Filed: Mar. 14, 2011
(86) PCT No.: PCT/EP2011/053791

§ 371 Date: Sep. 13, 2012

(30) Foreign Application Priority Data
Mar. 18, 2010 (DE) 10 2010 003 014.7

(51) Int. Cl. F16B 23/00; B25B 23/00

(52) U.S. Cl. 411/403; 81/460

(57) ABSTRACT

A drive formation for a rotary drive, for example a depression in the end face of a screw, has two regions with different cross-sections, but with a cross-sectional form having a certain similarity, arranged axially in succession. Due to the smaller cross section with a similar cross-sectional form, the transfer of torque can be better adapted to the form of a counter-sunk head of a countersunk head screw. The cross-sectional form corresponds to a central circular core with wing-like attachments attached thereto and protruding radially beyond the outer face of the core. The wings have side walls extending approximately parallel to one another in cross section, and therefore the wings have at least approximately the same thickness as far as their end forming an end wall. Said wings also have the same thickness when viewed over the depth of the formation, and therefore no forces causing the tool to be pushed out are produced.

The invention relates to a drive formation for a rotary drive, in particular for a screw drive formation, and to a drive formation of the respective tool.

Cross-shaped depressions are known as screw drive formations, and therefore the screw provided with such a drive formation is referred to as a crosshead screw. The side walls of the depression, which are provided to transfer the torque applied by the operator, extend at a specific incline with respect to a longitudinal section of the screw. Due to the inclined progression, when torque is introduced some of the force is diverted into a force causing the screwdriver to be pushed out from the crosshead.

It is also known to form depressions in screw heads, wherein the side walls of said depressions extend parallel to the longitudinal axis of the screw. An example of screw drive formations of this type is a hexagonal depression or a depression defined by circular arcs oriented so as to be reversed in an alternating manner.

Since screws having countersunk heads are also very frequently used, a depression with a relatively small cross section has to be used in the case of a screw drive formation with side walls extending parallel to the longitudinal axis of the screw, since the width of the depression conforms to the narrowest diameter of the screw head.

Screw drive depressions formed of a plurality of portions of identical cross sectional form but of different size are already known (GB 2390127 A, GB 2285940 A). Gradations are formed between the individual portions and are designed as planar areas extending transverse to the longitudinal axis of the screw. These areas are not available for torque transfer.

A screw drive formation in the form of depression having a non-circular cross section and a central circular blind hole is likewise known. The transition between the drive depression and the blind hole extends in the form of a flat, smooth cone. These areas are also not available for torque transfer (US 2007/0245863 A1).

The object of the invention is to create a screw drive formation that enables application of increased torques, does not generate forces causing the tool to he pushed out, and enables a long service life of the respective tools.

To achieve this object, the invention proposes a drive formation having the features of claim 1 and a drive formation having the features of claim 2. Developments of the invention are disclosed in the dependent claims.

The drive formation proposed by the invention thus makes it possible to additionally utilize the areas surrounding the wing region to apply torque. In specific cases, it is even possible to utilize just the end depressions in this surface or just the end protrusions, formed for example as ribs.

The end depressions, which for example may be formed as notches or grooves, have a base, which extends approximately transverse to the longitudinal axis of the screw or of the tool.

The end protrusions have an axially directed underside, which extends approximately transverse to The longitudinal axis of the screw or of the tool.

In a development of the invention, the proposed drive formation may have at least two axially adjoining wing regions of different cross-sectional size, wherein, in the case of a drive depression, the second region penetrating further into the screw head is smaller than the first region arranged further outward. The second region can thus be oriented toward the smaller size of a countersunk head in the region further removed from the end face, whilst the first region with the larger cross section can better utilize the larger diameter of the countersunk head in the outer region. In spite of the improved adaptation to countersunk heads, there is no force causing the tool to be pushed out from the recess. The same is true in the case of a screw drive formation In the form of a complementary protrusion.

The drive formation proposed by the Invention can be formed on a workpiece, that is to say an element which is to be rotated with the aid of a tool. The typical example of such a workpiece is a screw or a bolt.

To drive such a workpiece in rotation, a tool is used that may have the same drive formation. If it is desired or possible to forego some of the advantages of the invention, a screw of this type can also be rotated using a conventional tool, which for example has only one region in the form of a star with a circular core and radially outwardly protruding wings, or using a flat-head screw driver.

In accordance with a development of the invention, the area surrounding the wing region may be formed at a gradation between two wing regions.

However, it is also possible for the area surrounding the wing region to be formed on a preferably planar end face.

Since, in the case of a screw drive depression, the region with the smaller cross section has to be accessible through the region with the larger cross section, wings of the region with the smaller cross section may only be arranged at the point at which the wings of the region with the larger cross section are also arranged. However, it is possible for the region with the smaller cross section to have a smaller number of wings than the region arranged thereabove. It is particularly expedient, however, if, in accordance with a development of the invention, the number of wings in both regions is identical. Of course, this applies not only to a drive depression, but also to a drive protrusion.

In accordance with the invention, the second region has a smaller cross section. The dimensions of the cross section do not have to be smaller at all points, however. In accordance with a development of the invention, the width of the wings may be identical in both regions.

In accordance with another development of the invention, the side walls of the wings may extend parallel to one another in the axial direction, possibly with the exception of a draft angle.

The side walls of the wings are the part where the tool lies against the workpiece during rotation to transfer torque. It is therefore expedient for these areas to extend perpendicular to the rotation so that no force component causing the tool to be pushed out from the workpiece is produced.

In accordance with a development of the invention, the end walls of the wings of at least one region, preferably the region with the greater cross section, may extend parallel to the axis in the axial direction.

The side walls of the above-mentioned wings transition into the end wall of the respective wing and, at the other end, into the wall of the core. In accordance with the invention, the transition between the end walls of the wings and the side walls of the wings may be formed by an edge, at least in one of the two regions.

It is also possible, however, for this transition to be rounded.

It is possible that the two types of transition are combined with one another in one region, wherein it is also conceivable for both types of transition to be provided between the end wall and the side walls at a single wing.

An edge or rounded transition can also be formed in the case of the transition between the side walls of a wing and the side wall of the core, which is arranged between two wings in each case. These possibilities may also be combined with one another within one region and even within a single wing.

These above-mentioned transitions can be seen in a cross section of the rotary drive formation perpendicular to the longitudinal axis.

Since the wings of the region with the smaller cross section have a shorter radial length than the wings of the region with the greater cross section arranged directly thereabove, the wings of the region with the greater cross section also have a base. In this case, the transition between the end wall of the wing and the base of the wing can be formed by an edge.

It is also possible, however, for this transition to be rounded.

There is naturally also a transition between the base of the wing of the region with the greater cross section and the end wall of the wing with the smaller cross section. This transition can be formed by an edge or by a rounded edge.

These above-mentioned transitions can be seen from an axial section through the drive formation.

In accordance with a further feature, the invention proposes providing the end wall of the wing with a contour that corresponds to a circular arc about the axis of the drive formation.

The transition between the side walls of the wings and the core can be formed by an edge, possibly by a chamfered edge.

It is also possible, however, and likewise proposed by the invention for this transition between the side walls of the wings and the region of the outer wall of the core, which is arranged between two wings in each case, to be rounded.

It has already been mentioned that the side walls of the wings extend in parallel to one another in an axial direction, In accordance with a development according to the invention of the embodiment of the side walls of the wings, these side walls may be planar.

In accordance with the invention, the progression of the two side walls of a wing, said side walls defining the wing, can be designed such that the side walls or the contour thereof converge toward the tip of the wing, wherein the angle moves within a very small range since a real wing tip is not desirable

In accordance with the invention, however, the contours of the side walls of the wings may extend parallel to one another.

As also proposed by the invention, it is even possible for the side walls of the wings to diverge toward the wing tip.

In an alternative embodiment, the contour of the side walls of the wings may also extend in a curved manner, similarly to the end wall of a wing. For example, in accordance with a development, the outer contour of the drive formation may be formed of concave and convex arcs adjoining one another in an alternating manner.

In accordance with the invention, in order to again provide better adaptation to the form of a countersunk head, the size of the cross section can again be reduced continuously at increasing depth in the region with the smaller cross section, so that the side walls of the drive formation converge toward the base in an axial section, preferably along a line that is concave toward the outer face.

It was previously mentioned that the drive formation has two adjoining axially aligned regions of different cross-sectional size. In accordance with a development of the invention, a third region, of yet smaller dross section, may now be adjoined in an axially aligned manner. Two gradations are thus formed in an axial section, instead of just one gradation as in the embodiment with two regions.

For example, this third region may then have a circular cross section in accordance with a first embodiment, that is to say said third region may have no wings The side walls of this region with a circular cross section may lie over a circular cone with a small angle.

It is also possible, however, for this third region to have the cross-sectional form of a star with a circular core and radially outwardly protruding wings. The features mentioned and described with regard to the wings and transitions in the first regions may also be provided, mutatis mutandis, in the third region.

In accordance with another development of the invention, the side walls of the core may lie between the wings over a circular cone in at least one region. By inserting the tool, there is planar contact between the tool and the side walls of the core, which guides and centers the tool during the rotational movement.

Further features, details and advantages of the invention will emerge from the claims and the abstract, of which the wording is hereby incorporated by reference in the content of the description and the following description of preferred embodiments given with reference to the drawings, in which:

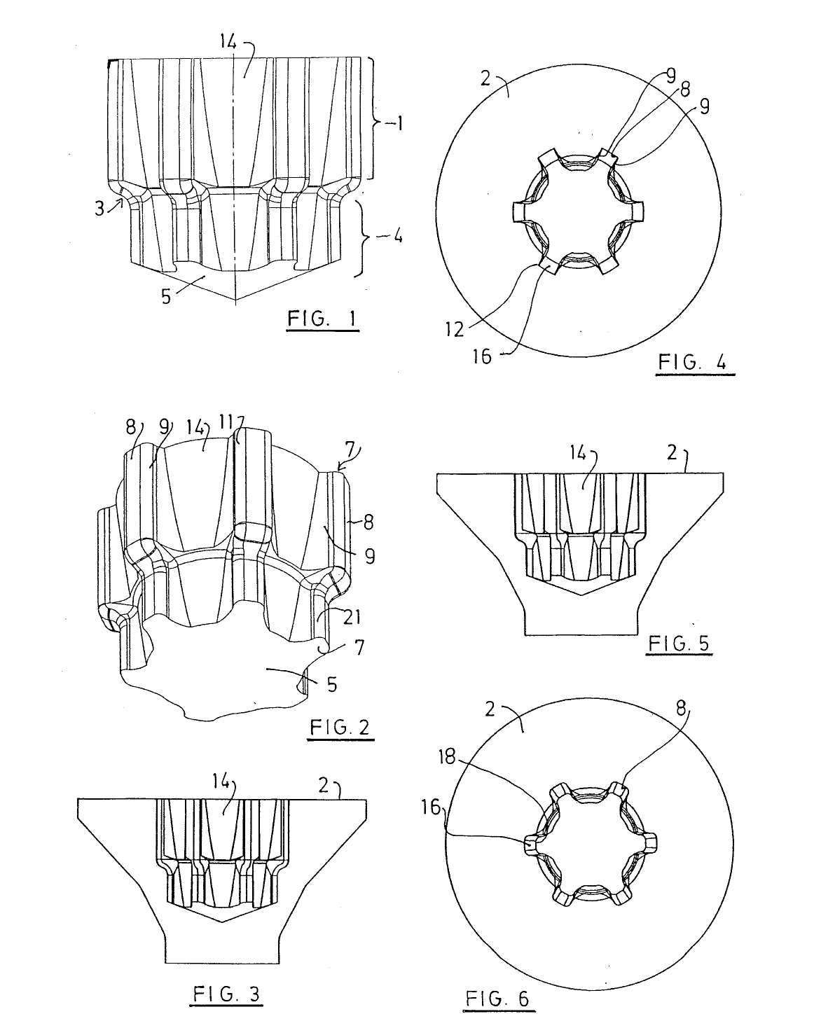

FIG. 1 shows a side view of a first embodiment of a screw drive formation;

FIG. 2 shows a perspective view of the screw drive formation in FIG. 1;

FIG. 3 shows a schematic section through the screw head of a screw;

FIG. 4 shows an end view of the screw head in FIG. 3;

FIG. 5 shows a section through a screw head in a second embodiment;

FIG. 6 shows an end view of the screw in FIG. 5;

FIG. 7 shows an illustration corresponding to FIG. 1;

FIG. 8 shows an illustration corresponding to FIG. 2 of the screw drive formation according to FIG. 7;

FIG. 9 shows a side view of a screw drive formation in accordance with a further embodiment;

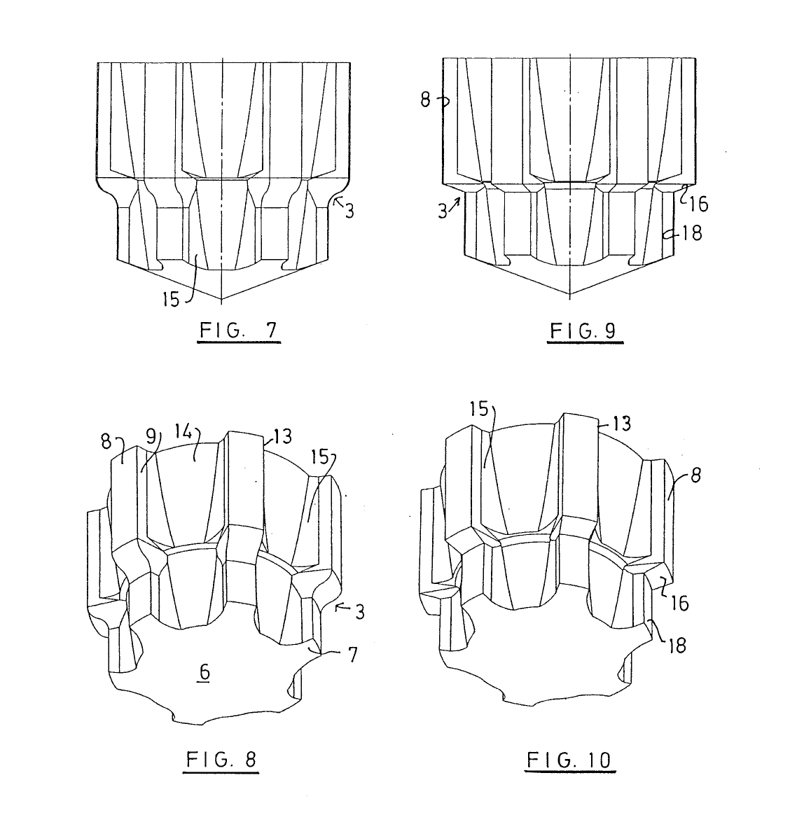

FIG. 10 shows a perspective Illustration of the drive formation according to FIG. 9;

FIG. 11 shows a side view of a screw drive formation in yet a further embodiment;

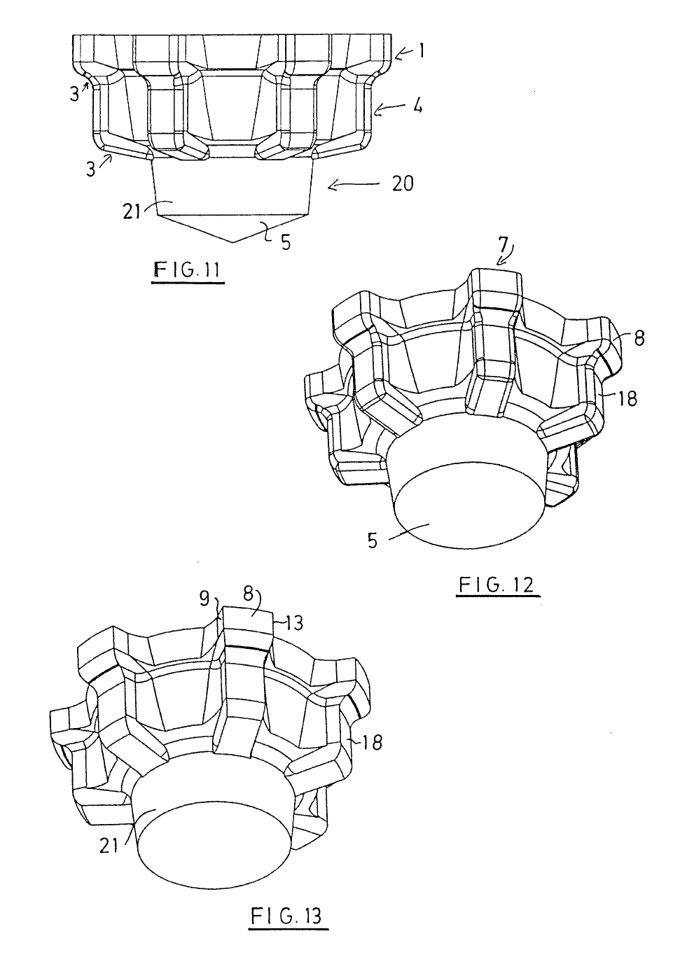

FIG. 12 shows a perspective view of the embodiment according to FIG. 11;

FIG. 13 shows a perspective view of an embodiment that has been amended with respect to FIG. 12;

FIG. 14 shows the end view of a screw with a drive formation according to FIG. 13;

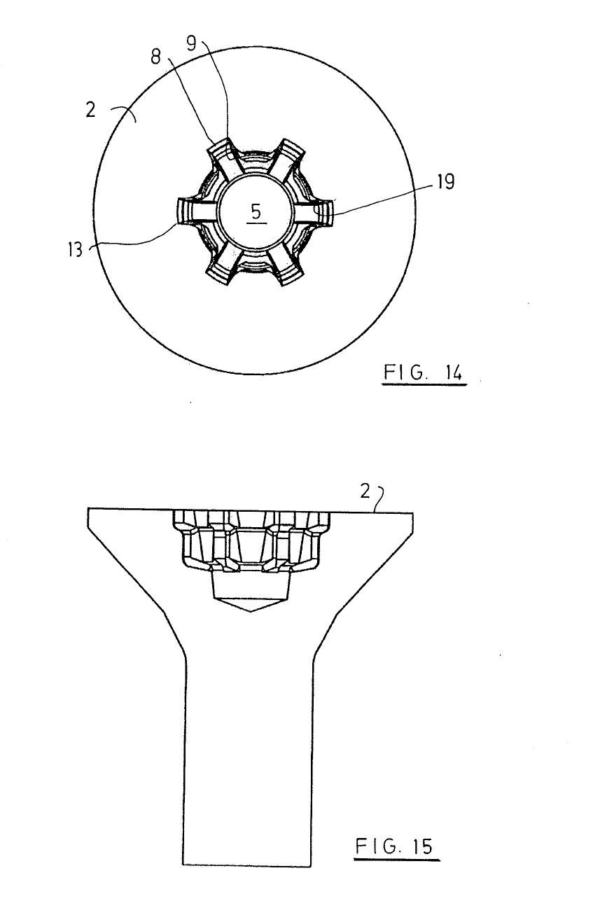

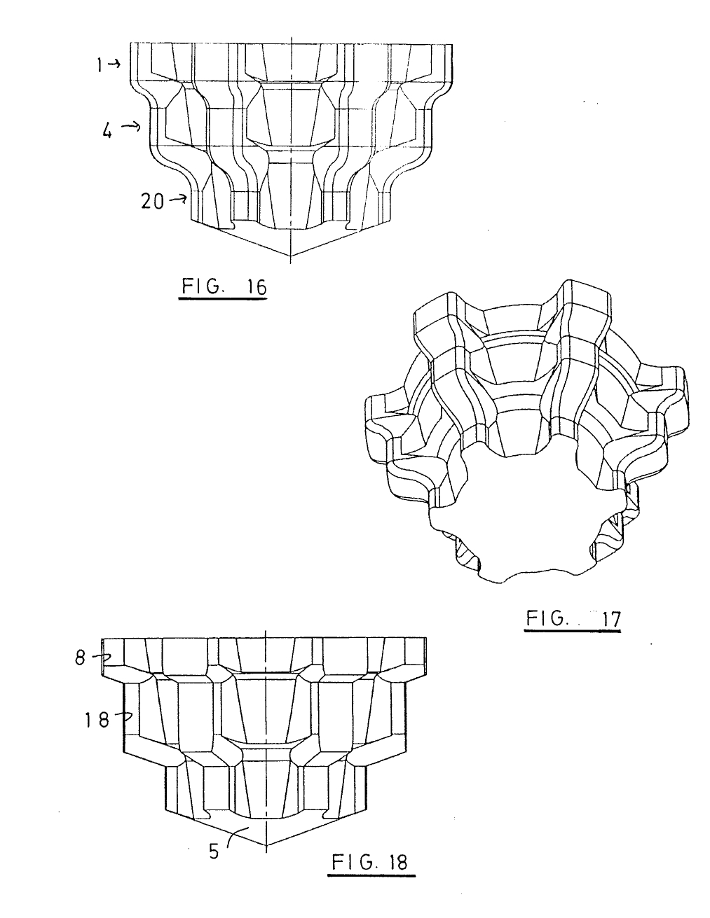

FIG. 15 shows an axial section through the screw head end of a screw according to FIGS. 13 and 14;

FIG. 16 shows a side view of a screw drive formation in accordance with yet a further embodiment;

FIG. 17 shows perspective illustration of the embodiment according to FIG. 16;

FIG. 18 shows a side view corresponding to FIG. 16 of a further embodiment;

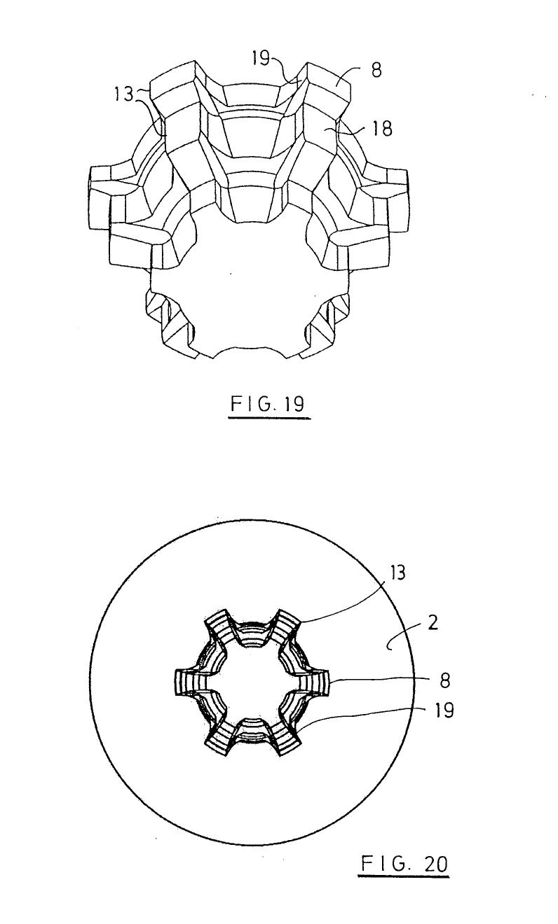

FIG. 19 shows an illustration corresponding to FIG. 17 of the embodiment according to FIG. 18;

FIG. 20 shows a side view of a screw with a screw drive formation according to FIG. 19;

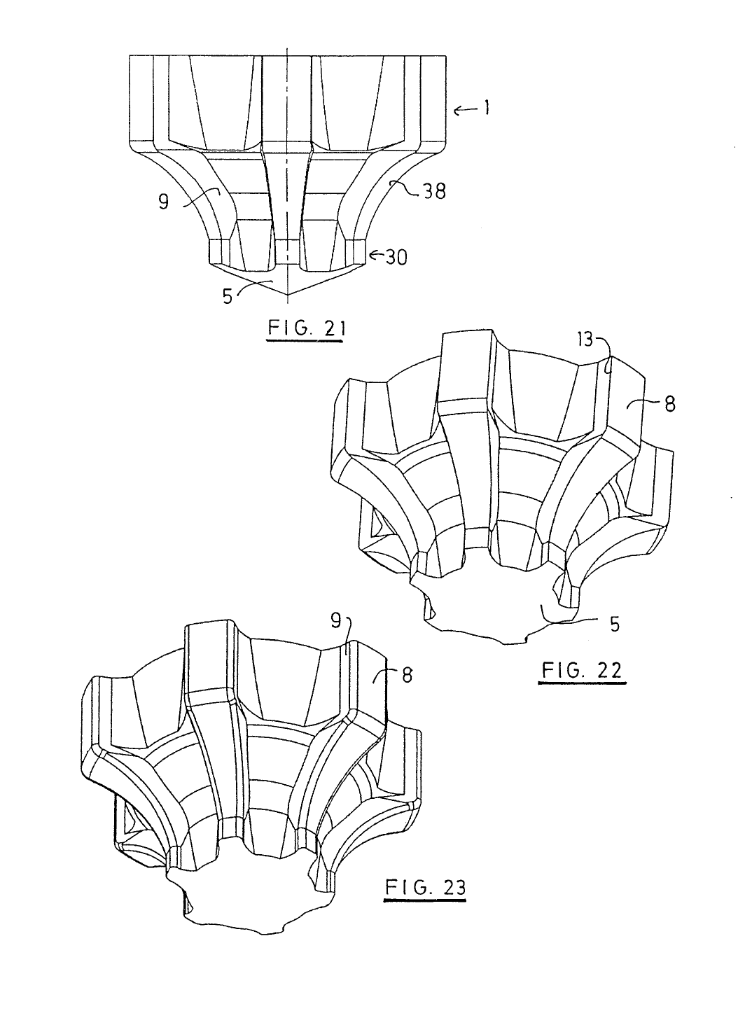

FIG. 21 shows a side view of a screw drive formation in a further embodiment;

FIG. 22 shows a perspective view of the embodiment according to FIG. 21;

FIG. 23 shows an illustration corresponding to FIG. 22;

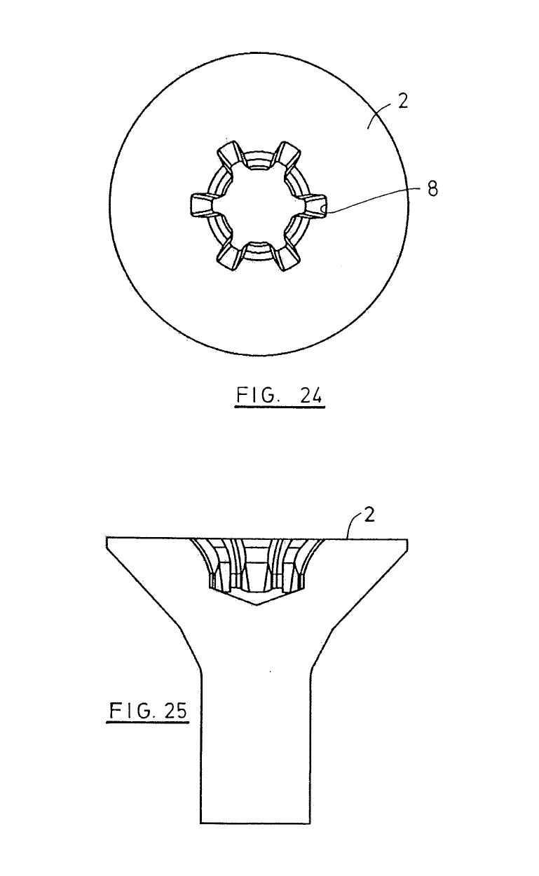

FIG. 24 shows a side view of a screw with an embodiment of the drive formation similar to FIG. 21;

FIG. 25 shows a section through the screw head end of the screw according to FIG. 24;

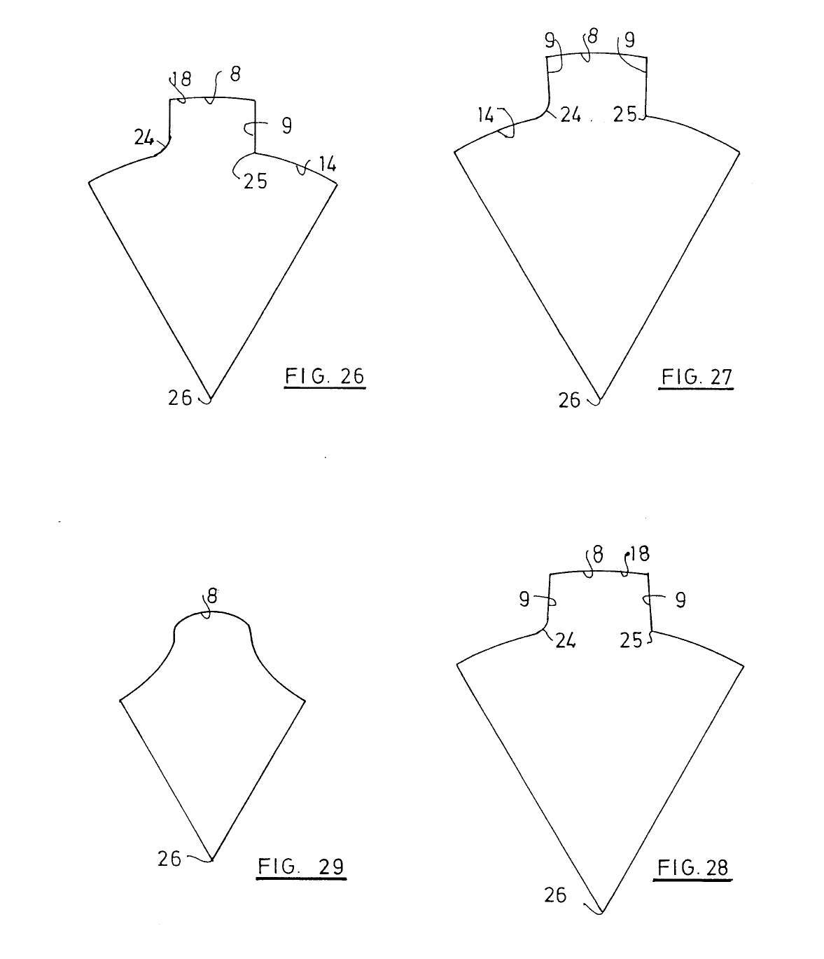

FIG. 26 shows the progression of the contour of a screw drive depression in the region of a wing;

FIG. 27 shows an illustration corresponding to FIG. 26;

FIG. 28 shows an illustration corresponding to FIGS. 26 and 27;

FIG. 29 shows a further embodiment of the progression of the contour of the screw drive formation;

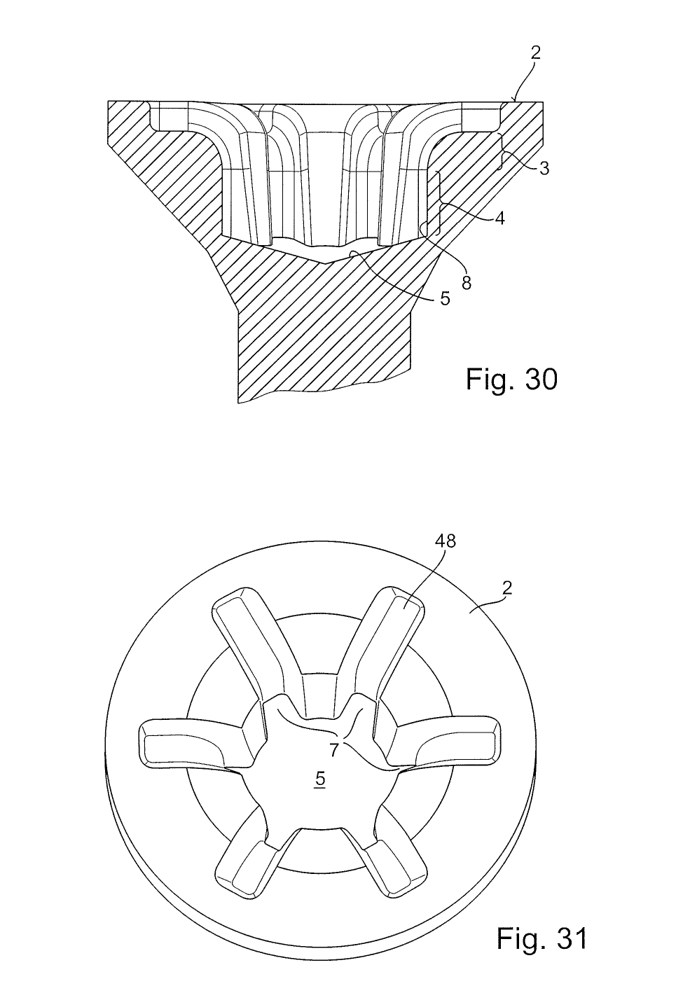

FIG. 30 shows an axial section through a further screw drive;

FIG. 31 shows a perspective illustration of the screw head in FIG. 30;

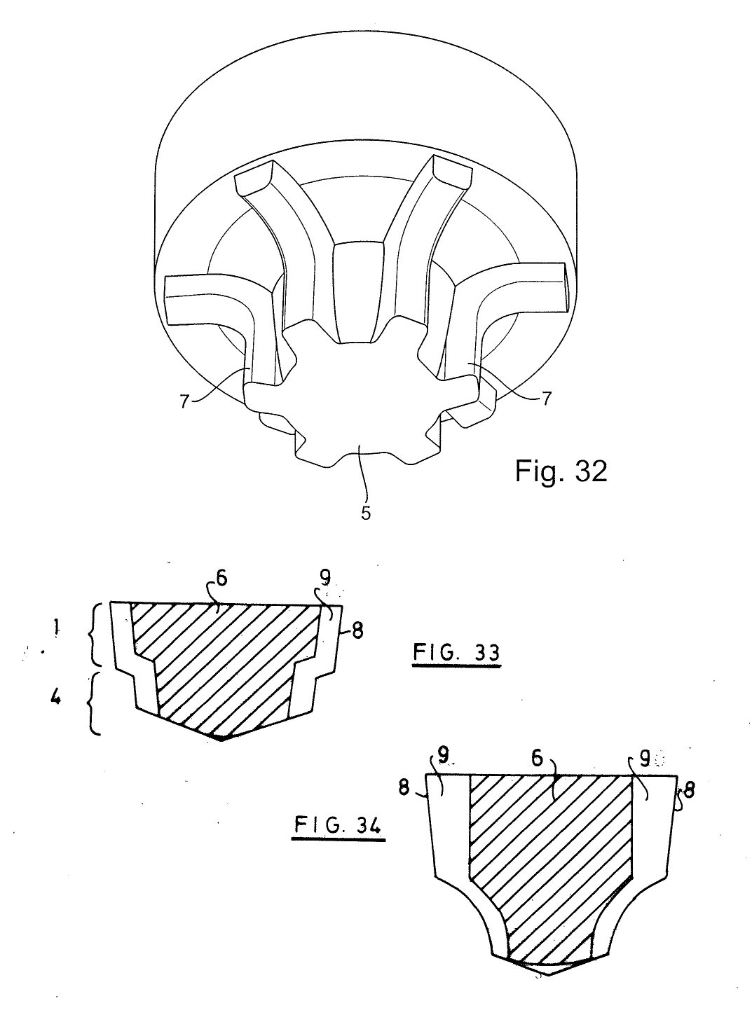

FIG. 32 shows a perspective view of a tool for driving the screw in FIGS. 30 and 31;

FIG. 33 shows an axial section through a further embodiment;

FIG. 34 shows an axial section corresponding to FIG. 33 through yet a further embodiment of a drive formation.

Reference is made first to FIG. 1. The form illustrated in this case can be considered both as the drive end of a tool and as the form of the depression in a workpiece to be driven in the direction of rotation. To simplify the description, it is assumed that it is the form of the depression in a screw head, as illustrated for example in FIG. 3 and in FIG. 5. The screw drive formation contains a first region 1, which starts from the end face 2 of a screw. This first region 1, which has a first cross section, is adjoined by a second region 4, which has a certain similarity to the first region, via a gradation 3, which may he rounded. The second region 4 ends in a smooth, tapered base 5.

The form of the cross section of the second region 4 and of the first region 1 can be seen for example in FIG. 2. The cross section forms the shape of a star with a central core 6, adjoined radially outwardly by six wings 7 in the illustrated example. The wings 7 are distributed uniformly over the periphery. This is expedient, but not absolutely necessary, since wings arranged non-uniformly may also be expedient for some purposes. Screws that can only be actuated using a special tool can thus be produced.

In the illustrated embodiment the number of wings 7 in both regions 1, 4 is identical. Since the passage in a drive depression to the wings in the lower region 4 passes through, and must pass through, the wings 7 in the upper region 1, the wings 7 in the lower region have to be arranged directly beneath the wings 7 in the upper region 1. In addition, the lower region 4 naturally cannot have more wings 7 than the upper region 1. It may, however, have fewer wings. In the illustrated embodiments however, the lower region 4 has the same number of wings 7 as the upper region 1.

Between the wings, the contour of the side walls of the core lies over a circular arc.

As can be seen best in FIGS. 4 and 6, the wings 7 have an end wall 8, two side walls 9, and a base 16, which is shorter than the side walls 9 in the first region 1. At the axial transition to the end walls 18 of the smaller region 4, the base 16 forms a gradation. This gradation 3 may extend in a rounded manner, as shown in the side view of FIG. 1. It can also form a sharp edge, however.

The side walls 9 of the wings 7 extend radially and at least approximately parallel to one another.

It has already been mentioned that the transition between the base of the wings 7 in the upper region 1 and the side walls 9 of the wings 7 in the lower region can extend in a rounded manner (see FIG. 1 and FIG. 2), but that this transition can also be achieved via an edge.

The transition between the end wall 8 of a. wing and the side walls 9 of this wing 7 can likewise extend in a rounded manner, as can be seen in FIG. 2. In this case, this transition 11 (see FIG. 2) is rounded. It can be seen from the end view of FIG. 4 that, in this case too, an edge 12 is formed. The rounded transition can also be seen in FIG. 6.

It can also be seen from FIG. 2 that the transition 21 between the end walls 8 and the side walls 9 of the wings 7 in the lower region 4 likewise progresses in a rounded manner, similarly to the upper region 1. It is expedient to design the transitions in both regions 1 and 4 in the same manner, although designing these transitions so as to be different in the two regions also lies within the scope of the invention.

FIGS. 7 and 8, which are to be viewed together, show that the transition between the side walls 9 and the end walls 8 of the wings 7 is sharp-edged in the upper region 1 and in the lower region 4, and therefore a sharp outer edge 13 is formed in this case.

The transition between the side walls 9 of the wings 7 and the wall 14 of the core 6 formed between the wings 7 extends along an inclined transitional area 15.

It has been mentioned that the gradation 3 can be rounded or sharp-edged. FIGS. 9 and 10, which are to be viewed together, show such an embodiment, in which the transition between the end wall 8 of a wing and the base 16 of the wing is sharp-edged, as is also the transition between the base 16 of the wing 7 and the end wall 18 of the wing arranged therebelow. The sharp-edged property and the rounded transition of this gradation 3 can be provided at both locations.

This sharp-edged transition can also be seen clearly from the perspective illustration in FIG. 10.

Whereas only two adjoining regions of different cross section are provided in the embodiments discussed previously, the following FIGS. 11 to 20 now show embodiments with three adjoining regions of different cross-sectional size. In the embodiment discussed first according to FIGS. 11 to 15, a region 20 with a circular cross section adjoins the first regions 1 and 4. The first two regions 1 and 4 are structured identically to the embodiment in FIG. 2 for example, with the exception of their axial extent. The third region 20, of which the wall 21 lies over a circular conical surface, is used to guide the tool during the rotational movement. This is important in particular at high rotational speed. This third region 20 again has a base 5, as in the first embodiment.

In the embodiment illustrated in FIG. 13, the third region. is structured identically to the embodiment in FIG. 11 and FIG. 12, with the exception of the actual tip 5, whilst the first two regions 1 and 4 are structured as in the embodiment according to FIG. 7 and FIG. 8, The transition between the end walls 8 and the side walls 9 of the wings 7 is sharp-edged in the two first regions, whereas the transition of the gradations 3 between the end wall 8 of the wings 7 and the base 16 thereof and between the base and the end wall 18 of the wing 7 arranged therebelow extends in a rounded manner.

FIG. 14 then shows a plan view of the end face 2 of a screw, which has a drive depression corresponding to FIG. 13. The sharp-edged transitions between the end walls 8 and 18 and the side walls 9 can be seen, leading to the formation of an edge 13.

For clarification, FIG. 15 shows an axial section through the screw drive end of a screw, which has such a drive depression. It can therefore be seen that the radial spacing between the outer contour of the countersunk head and the outer wall of the screw drive depression is at least approximately identical all over.

In the case of the drive formation for rotary drives, said drive formation being illustrated in FIG. 16, the third region 20, which adjoins the first regions 1 and 4 axially, also has a cross-sectional form of a star with a core and six wings 7. All details discussed already with regard to the transitions between end walls, side walls and bases of the individual wings also apply in this case to the transitions between the second and third portion and for the wings of the third portion.

In the embodiment according to FIG. 16, all transitions extend in a rounded manner, which can also be seen in FIG. 17. By contrast, in the embodiment in FIG. 18, the transitions are sharp-edged.

FIGS. 19 and 20 show an embodiment of a drive formation, in which the transitions between the end walls 8, 18 of the wings 7 and the side walls 19 are sharp-edged in all three regions 1, 4 and 20. Sharp edges 13 are thus formed in all three regions 1, 4 and 20. In this case too, the transition between the end walls 8 and the base 16 is likewise sharp-edged. These sharp-edged transitions can also be seen in the end view of FIG. 20.

With regard to the side walls of the core of the cross section in the individual regions, it remains to be mentioned that these side walls lie over a circular conical surface 14 in all embodiments, which can be seen both in the side views and in the perspective illustrations. This cone shape is likewise used to center and guide the tool so as to thus also ensure that the tool remains axially aligned. This is important in particular at high rotational speeds. In addition, the centering process is used to distribute the torque transfer as uniformly as possible over the corresponding areas. For adequate centering and guidance, it may be sufficient for just the lower region to be cone-shaped.

Whilst in the embodiments discussed previously, the end walls 8, 18 of the wings 7 extend parallel to the longitudinal axis of the recess or of the protrusion, the embodiments according to FIGS. 21 to 25 show that this is not absolutely necessary. In the embodiment illustrated in FIG. 21, the first region 1 is structured identically to the embodiments discussed previously. However, it is adjoined by a transitional region in which the end wall 38 of the wing reduces continuously along a concave or conical outer contour and transitions into an end portion 30, which for example corresponds to the end portion of the embodiment according to FIGS. 16 to 18. The transitional portion and the end portion 30 as well as a single portion within which the cross section reduces continuously can be seen. The transitions between the end walls 38 and the side walls 9 may also have the same features in this transitional region as the previously described embodiments in regions 1, 4 and 20.

FIG. 22 shows sharp-edged transitions between the side walls 9 and the end walls 8 and 38, whilst the transitions in axial section extend in a rounded manner.

In the embodiment illustrated in FIG. 23, the transitions between the end walls 8 and 38 into the side walls 9 of the wins 7 are also rounded.

Whilst in the embodiments illustrated in FIG. 21 to FIG. 23 the first region 1 is still cylindrical and only the adjoining second region is shaped in the manner of a trumpet. FIGS. 24 and 25 show another embodiment, In this case, the first region is provided with a continuously tapering cross-sectional size, whilst the wings in the adjoining inner second region are again of constant cross-sectional size over the depth of the recess. In this case too, the side walls of the core between the wings also again lie over a circular conical surface.

It was also mentioned at the outset that the side walls 9 of the wings 7 extend at least approximately parallel to one another in side view or in cross section. The fact that they likewise extend parallel to one another in an axial section is clear from the end view. The following FIGS. 26 to 28 will illustrate the progression of the contour of the side walls 9 and of the end wall 8 and 18 of the wings 7 in greater detail. These, very schematic, figures show the progression of the contour of the cross section in a detail extending from either side of a wing 7.

A wing 7 is defined by an end wall 8 and two side walls 9. The side walls 9 then transition into the outer wall 14 of the core of the star. In the embodiments of FIG. 26 to FIG. 28, the contour of the end wall 8 extends along a circular arc about the axis of the drive formation, which, in the case of a screw, coincides with the longitudinal axis of the screw. In the embodiment of FIG. 26, the contours of the side walls 9 extend parallel to one another. The transition between the side walls 9 of the wings 7 and of the outer wall 14 of the core may be rounded, so that a channel 24 is formed at this point. It can also be formed by an edge 25 however, which is illustrated at a wing 7 in each of the three figures. This does not mean that these different transitions are actually present, or have to be present, at a wing 7.

In the highly schematic embodiment in FIG. 27, the contours of the side walls 9 extend in a diverging manner from the central axis of the drive formation, at an angle in a range of 3 to 5° for example.

In the embodiment of FIG. 28, the contours of the two side walls 9 of the wing 7 extend in a converging manner from the central axis 26. The angle may lie in the same angular range as in the embodiment in FIG. 27.

FIG. 29 differs considerably from the previous figures. The transition between the core of the star and the wings 7 extends gradually and continuously in this case. The end wall 8 of a wing is formed by an arc, which no longer corresponds to a circular arc about the central axis 26, but is curved much more considerably. The end wall transitions directly into a contour that is curved in the opposite direction and to a lesser extent, without any deflection or specific transition. In this case, the outer contour of the screw drive formation is formed by lines curved alternately in a concave and convex manner.

Reference is now made to the embodiment illustrated in FIGS. 30 and 31 of the rotary drive formation of a screw head. FIG. 30 shows an axial section through such a screw head. When starting from the lower end of the recess, the rotary drive formation starts in the form of a depression, in the same manner as in the embodiment in FIG. 1. Starting from a smooth, conical base 5, a first region 4 is provided, in which the cross section of the recess has the form of a star with a central core and six wings 7. The end walls 8 of the wings extend parallel to the longitudinal axis in the axial section. The region of the core 6 within the first region 4 between the wings 7 lies over a cone.

This lower region 4 is adjoined by a transitional region in the form of a gradation 3, in which the side contour of the wings 7 extends in a sweeping manner. The side contour of the wings 7 then transitions into the upper region, in which the original side contour of the wings 7 transitions into the base of a groove. Starting from the end face 2 of the screw, radially extending grooves 48 are formed in the extension of the wings 7 in the lower region 4, it also being possible to refer to said grooves as wings. It is essential (see the perspective illustration in FIG. 31) that a plurality of radial grooves 48, not reaching as far as the outer edge of the screw head, is provided in this planar end face 2, said grooves forming the contact areas in both directions of rotation for a tool. In this case, a tool for rotational engagement can thus engage a rib, a protrusion or the like directed downwardly, that is to say axially. The contact area is thus increased, which in turn leads to a reduction in surface pressure.

The form of the transition between the radially extending grooves enabling end-face engagement and the wings of the engagement portion 4 can be seen from the perspective illustration in FIG. 31.

The radially extending grooves 48, which form an end depression in the end face 2 of the illustrated screw, have a base, which extends in a transverse plane transverse to the longitudinal axis of the screw in the radial end region. Also in all other embodiments illustrated in the preceding figures, the gradation transition 3 is designed such that the base of this gradation lies very close to a transverse plane. In particular, the invention proposes the possibility of the base enclosing an angle of at most 45°, with the exception of the transition thereof into the two regions connected by the gradation 3, with a plane extending transverse to the longitudinal axis.

That which is illustrated particularly clearly in the embodiment according to FIGS. 30 and 31 also applies to the preceding embodiments, since a gradation transition 3, in which a part of a tool protruding in the axial direction may produce rotational engagement, is provided anywhere in the region between a portion with a greater crows section and a portion with a smaller cross section.

An example for the form of such a tool is illustrated in FIG. 32. The illustrated form is complementary to the form of the recess in FIGS. 30 and 31. It can be seen that six ribs 7 are provided on the tool starting from the free end thereof and initially extend axially. They then bend outwardly in a sweeping form and extend radially and transverse to the longitudinal axis in their end region.

In the embodiments discussed previously, with the exception of the embodiment illustrated in FIG. 24 and FIG. 25, the end wall 8 of the wings 7 extends parallel to the longitudinal axis in an axial section. This is not necessary, however.

The simplified axial section through a screw drive formation, for example a tool, shows that the end wall 8 of the wings 7 in both regions 1, 4 may also lie over a cone, similarly to the region of the core 6 between the wings 7. In the illustrated example, the cone angle, over which the end walls 8 of the wings 7 lie, is identical to the cone angle of the outer face of the core 6 between the wings 7.

The angle between the longitudinal axis and the end wall 8 is approximately 6° in the axial section.

FIG. 34 shows a further axial section, in which, in the portion with the greater cross-sectional area, the core 6 lies over a cylindrical surface in the region between the wings 7 in the axial section. Similarly to the embodiment according, to FIG. 33, the end walls 8 of the wings 7 lie over a conical surface in said region, said conical surface having approximately the same angle to the longitudinal axis as in the embodiment according to FIG. 33.

In the region 4 with the smaller cross-sectional area, the walls of the core 6 and the end walls 8 of the wings 7 extend in a manner similar to that in the embodiment according to FIGS. 21 to 23.

Combinations of the progressions as illustrated herein are, of course, also possible. For example, the end wall 8 of the wings 7 could lie over a conical surface in the first region 1 and over a cylindrical surface in the second region 4. The same also applies to the outer wall of the core 6 between the wings 7.

1. A drive formation for a rotary drive, formed as
a circumferentially closed depression, which
has at least one wing region (4) with a cross section in the form of a star with a circular core and radially outwardly protruding wings (7),
said region being adjoined axially on the side facing away from the base (5) of the depression by an area radially surrounding the wing region (4) by means of its outer periphery,
an end depression (48) being formed in said area in the axial extension of at least one wing, preferably all wings (7),
said end depression forming a rotational engagement area for a lower end protrusion of a tool or workpiece protruding in the axial direction.

2. A drive formation for a rotary drive, formed as
a protrusion with a peripheral side wall, which
has at least one wing region (4) with a cross section in the form of a star with a circular core and radially outwardly protruding wings (7),
said region being adjoined axially on the side facing away from the free end of the protrusion by an area radially surrounding the wing region (4) by means of its outer periphery,
an end protrusion (48) being formed in said area in the axial extension of at least one wing, preferably all wings (7),
said end protrusion forming a rotational engagement area for an end depression returning in the axial direction.

3. The drive formation as claimed in claim 1, wherein the wing region (4) is adjoined by a second region (1) with a greater cross section in the form of a star with a circular core and radially outwardly protruding wings (7), of which the core has the same axis as the core of the wing region (4) and of which the wings (7) are arranged at the same point as the wings (7) of the wing region (4).

4. The drive formation as claimed in claim 3, wherein the area surrounding the wing region (4) is formed at a gradation between two wing regions (1, 4).

5. The drive formation as claimed in claim 3, wherein the area surrounding the wing region (4) is formed at an end face (2).

6. The drive formation as claimed in claim 3, wherein the number of wings (7) in both regions (1, 4) is identical.

7. The drive formation as claimed in claim 3, wherein the width of the wings (7) in both regions (1, 4) is identical.

8. The drive formation as claimed in claim 3, wherein the side walls (9) of the wings (7) extend parallel to one another in the axial direction, possibly with the exception of a draft angle.

9. The drive formation as claimed in claim 3, wherein the end walls (8, 18) of the wings (7) in at least one region (1, 4) extend parallel to the axis in the axial direction.

10. The drive formation as claimed in claim 3, wherein the end wall (8, 18) of the wing (7) extends along a circular arc about the axis of the drive formation.

11. The drive formation as claimed in claim 3, wherein the side walls (9) of the wings (7) are planar.

12. The drive formation as claimed in claim 11, wherein, in cross section, the side walls (9) of at least one wing (7) converge toward the tip of the wing or diverge toward the tip of the wing and the side walls (9) of at least one other wing (7) extend in parallel.

13. The drive formation as claimed in claim 1, wherein the side walls of the drive formation converge toward the base in an axial section, preferably along a line that is concave toward the outer face.

14. The drive formation as claimed in claim 1, wherein the wing region (4) is adjoined by a third region (20), of further reduced cross section.

15. The drive formation as claimed in claim 14, wherein the third region (20) has a circular cross section or has the cross-sectional form of a star with a circular core and radially outwardly protruding wings (7).

16. The drive formation as claimed in claim 15, wherein the side walls (14) of the core between the wings (7) lie over a circular cone in at least one region (1, 4, 20).

17. The drive formation as claimed in claim 16, wherein the number of wings (7) is at least three, preferably at least five.

18. The drive formation as claimed in claim 1, wherein a gradation (3) is formed between two adjacent regions (1, 4, 20).

19. The drive formation as claimed in claim 18, wherein the gradation (3) is formed in at least a step form or a conical form as the frustum of a cone.

20. The drive formation as claimed in claim 18, wherein the gradation (3) has wings (7) at the same point as the regions (1, 4, 20) connected by said gradation,

21. The drive formation as claimed in claim 20, wherein at least one wing (7) is guided continuously from the first region (1) into the second region (4) and/or is guided from the second region (4) into the third region (20).

22. The drive formation as claimed in claim 1, wherein at least one region is cylindrical or is shaped in the manner of a frustum of a cone.

23. A tool comprising a drive formation according to claim 1.

24. A workpiece comprising a drive formation according to claim 1.
